(19) United States
(12) Patent Application Publication
(10) Pub. No.: US 2015/0143483 A1
(43) Pub. Date: May 21, 2015

(54) Device and Method for Identity Authentication Management

(71) Applicant: WWTT TECHNOLOGY CHINA, Dong (CN)

(72) Inventors: Kwok fong Wong, Heshan (CN); Pui yi Ching, Heshan (CN)

(73) Assignee: WWTT TECHNOLOGY CHINA, Jiangmen (CN)

(21) Appl. No.: 13/881,363

(22) PCT Filed: Nov. 10, 2012
(86) PCT No.: PCT/CN2012/084422

§ 371 Date: Apr. 24, 2013

(30) Foreign Application Priority Data
Aug. 13, 2012 (CN) 201210285041.0

(51) Int. Cl. H04L 29/06; G06K 9/00

(52) U.S. Cl. CPC H04L 63/0861; G06K 9/00013; G06K 9/00087
USPC 726/6

(57) ABSTRACT

The invention discloses a device for identity authentication management comprising a client and a background. The client includes terminal unit and fingerprint sensor, which includes a collection and recognition device for collecting fingerprint information and a memory for storing fingerprint information and user information corresponding to the fingerprint information, and terminal unit is used for registering or recognizing the fingerprint information collected by the fingerprint sensors. The background includes an identity authentication server interconnecting with the terminal units and multiple application management areas interconnecting with identity authentication server and including application units and application information. When the fingerprint information is registered or recognized by the terminal units, the identity authentication server generates or compares the user information corresponding to the fingerprint information, and then in the application management areas operations on the application units or application information can be performed for users.

### FIELD OF THE INVENTION

The invention relates to a device and method for identity authentication management.

### DESCRIPTION OF THE RELATED ART

Network plays an increasingly important part in our life with the rapid development of internet, and various applications on network such as browsing webpage become a necessary part of daily life. Currently, we generally manage the websites or applications commonly used by means of a favorite so that they can be rapidly accessed. However, in fact, only the website linking is stored in the favorite, therefore, although the user can enter the website after clicking, but the other operations such as user login are necessarily performed on the linked website. Even, in some platforms, memory management is utilized on the websites accessed usually by the user so that they can be selected conveniently, but this would cause at least one disadvantage that any one accessed this computer can see such websites, and thus the privacy and safety is not enough for the users. Accordingly, in order to utilize network linking's and applications safely and quickly, it becomes an increasingly urgent problem to be solved for us to perform centralized management on such network linking's and various applications as well as the information such as user login.

### SUMMARY OF THE INVENTION

One object of the invention is to provide a device and method for identity authentication management, by utilizing such a device and method, any one of users can utilize the relevant applications rapidly, and the privacy of any user can be ensured.

One technical solution of the invention is to provide a device for identity authentication management, comprising:

A client, which comprises a plurality of terminal units and multiple fingerprint sensors interconnecting with each of the terminal units respectively,

Wherein each of the fingerprint sensors includes a collection and identification device for collecting fingerprint information and a memory for storing fingerprint information and user information corresponding to the fingerprint information; and the terminal units being used for registering or recognizing the fingerprint information collected by the fingerprint sensors; and
a background, which comprises an identity authentication server interconnecting with the terminal units and a plurality of application management areas interconnecting with the identity authentication server,
wherein application units and application information are included in the application management areas, when the fingerprint information is registered or recognized by the terminal units, the user information corresponding to the fingerprint information is generated or compared by the identify authentication server, and in the application management areas operations on the application units and application information can be performed.

Preferably, the identity authentication server includes a user authentication unit for identifying user identity and a user archive management unit for storing the registered user information.

More preferably, the terminal units interconnect with the identity authentication server and the identity authentication server interconnects with the application management areas through a network respectively.

Preferably, the application units in the application management areas are selected from, but not limited to, the group consisting of game, mail, website or any combination thereof.

More preferably, the application information in the application management areas includes user name, password or the like.

More preferably, each of the application units in the application management areas includes a friend's management unit, in which friends and operations on friends can be managed by exchanging the fingerprint information.

Still more preferably, each of the application units in the application management areas includes a chat unit, and the client being provided with a chat software for encrypting or decrypting chat information in the chat unit.

Another technical solution of the invention is to provide a method for identity authentication management, comprising the steps of:
extracting fingerprint information of users by means of a collection and identification devices of fingerprint sensors;
registering or recognizing the collected fingerprint information by the terminal units;
generating new user information from the registered fingerprint information or comparing the user information corresponding to the fingerprint print with the user information stored by the identity authentication server; and
performing operations on the application units or application information in the application management areas by users.

Preferably, the collection and identification devices of the fingerprint sensors extract the fingerprint information of users, and the terminal units registering the collected user information corresponding to the fingerprint information, and the user authentication unit of the identity authentication server of the background generating new users from the registered fingerprint information, and storing the new user information in the user archive management unit of the identity authentication server.

More preferably, the collection and recognition devices of the fingerprint sensors extract the fingerprint information of users, and the terminal units further recognizing the collected fingerprint information, and the user authentication unit of the identity authentication server of the background comparing the user information stored in the user archive management unit with the user information corresponding to the fingerprint information.

Still more preferably, the operations on the application units or application information for a user is selected from deletion, addition or modification or any combination thereof.

By means of the above configuration and method, the present invention has the following advantages:

1. according to such platform, a user cannot enter the application management area until his/her identity passes the fingerprint verification, and thus the user privacy can be ensured.

2. according to the device and method for identity authentication management in the present invention, fingerprint sensors are configured additionally and the relevant user information is stored in the fingerprint sensors, and thus the security for users can be ensured, and the adverse effect on the user dada can be decreased when the fingerprint sensor or account is lost.

3. according to the present invention, a user can perform unified management on custom websites or other relevant applications, and on the accounts as well as passwords of the custom websites or applications, so that the user can log in the websites or other applications rapidly and accurately by scanning the fingerprint, and further finish the account login, from this, by utilizing the device of this invention, for a user, a lot of time can be saved, and it is not necessary to log in various accounts repeatedly in different websites, and particularly the security can be ensured greatly.

4. according to the present invention, the functions of friend's addition and friend's dialogue can be achieved, and thus any third part can not obtain the private messages without decryption.

### BRIEF DESCRIPTION OF THE DRAWINGS

FIG. 1 is a schematic diagram of a device for identity authentication management according to the invention;

FIG. 2 is an operation flow chart of a device for identity authentication management according to the invention for a new user; and

FIG. 3 is an operation flow chart of a device for identity authentication management according to the invention for an old user.

### DETAILED DESCRIPTION OF THE INVENTION

Preferred embodiments of the present invention will now be described in more detail hereinafter with reference to the drawings, so that the advantages and features of the invention can be easily understood by a person skilled in the art, thereby the protection scope of the invention can be defined more clearly.

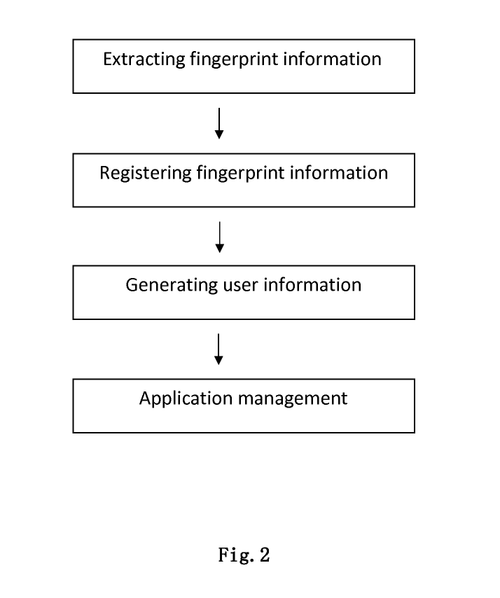

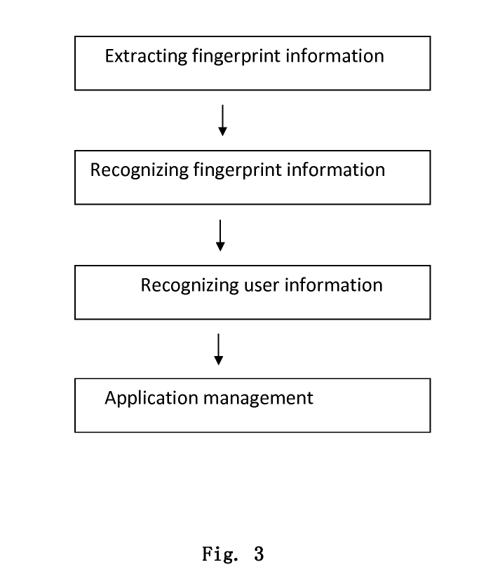

As shown FIGS. 2 and 3, one embodiment of this invention, a method for identity authentication management comprising the steps of:
A) extracting fingerprint information of users by means of the collection and recognition devices of fingerprint sensors;
(B) registering or recognizing the fingerprint information, comprising the following two steps:
(B1) extracting the fingerprint information for new users by the collection and identification devices of fingerprint sensors, and registering the user information corresponding to the collected fingerprint information by the terminal units.
(B2) extracting the fingerprint information for old users who has passed the identity verification by the collection and recognition devices of fingerprint sensors, and recognizing the collected fingerprint information by the terminal units.
(C) generating or comparing the user information by the identity authentication server of the background, comprising the following two steps:
(C1) for new users, generating new user information from the registered fingerprint information by the user authentication unit of the identity authentication server in the background, and storing the new user information in the user archive management unit of the identity authentication server.
(C2) for old users passing the identity verification, comparing the user information corresponding to the fingerprint information with the user information stored in the user archive management unit by the user authentication unit of the identity authentication server in the background.
(D) performing operations on the application units or application information in the application management areas, including deletion, addition or modification and the like.

Referring to FIG. 2, for new users, the operation steps include A, B1, C1 and D, and referring to FIG. 3, for old users, the operation steps include A, B2, C2 and D.

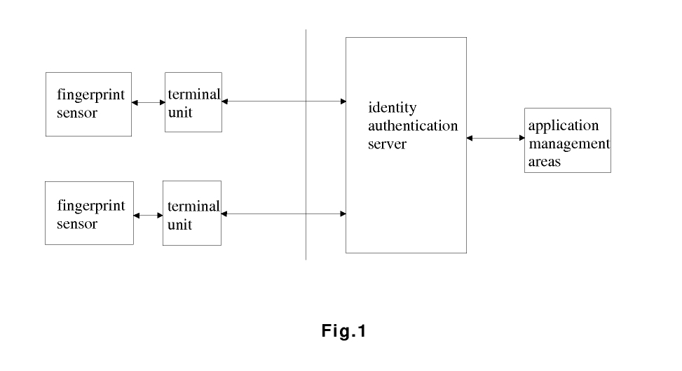

FIG. 1 shows a device for identity authentication management comprising a client and a background.
wherein the client includes a plurality of terminal units and multiple fingerprint sensors interconnecting with each of the terminal units, each fingerprint sensor includes a collection and recognition device for collecting fingerprint information and a memory for storing fingerprint information and user information corresponding to the fingerprint information. The terminal units are used for registering or recognizing the fingerprint information collected by the fingerprint sensors, which can be configured as one of computer, tablet computer, mobile phone, furthermore, each terminal unit is provided with at least one display screen capable of displaying the operations of users.

The background includes a identity authentication server interconnecting with the terminal units and multiple application management areas interconnecting with the identity authentication server.

The identity authentication server includes a user authentication unit for identifying the user identity and a user archive management unit for storing the registered user information.

Application units and application information are included in the application management areas, wherein each of the application unit includes (but not limited to)one or more of game, mail, website or the like, and the application information includes (but not limited to) one or more of user name, password and the like.

When the fingerprint information is registered or recognized by the terminal units, the identity authentication server will generate user information corresponding to the fingerprint information or compare the user information corresponding to the fingerprint information with the user information stored in the user archive management unit, and then the users can perform operations on application units or application information in the application management areas.

Each of the application units in the application management areas also can include a friend's management unit, in which friends and the operations on friends can be managed by exchanging fingerprint information. If a user “A” passing the identity verification would like to add another user “B” passing the identity verification, he/she may scan his/her fingerprint and sent a request by means of the friend's management unit, and when the user “B” receives the request and the fingerprint information from “A”, he/she confirms by scanning fingerprint thereof and feedbacks the fingerprint information to user “A”, thereby the function of friend's addition can be achieved.

Each of the application units in application management areas also includes a chat unit, and the client is provided with a chat software for decrypting or encrypting the chat information in the chat unit.

“A” can chat with “B” secretly after finishing friend's addition. Messages from “A” are sent to “B” by the chat software after encrypting with fingerprint information, and the messages received by “B” appear as messy codes in dialog box, however, “B” can decrypt such messy codes by utilizing fingerprint information and chat software to further read these messages. after decryption, the original characters appeared as messy codes can recombine automatically and further form characters of normal font, or alternatively, a mouse is in any position on the text of messy codes, and the messy codes in the position will appear as characters of normal or enlarged characters, in this case, even if other users operates on the client of “B”, the chat content can not be decrypted because they don't have the fingerprint information of “B”. Therefore, the device disclosed in the invention improves the security greatly.

The terminal units interconnect with the identity authentication server, and the identity authentication interconnects with the application management areas respectively.

It is to be noted, however, that only the preferred embodiments are illustrated with reference to the accompanying drawings herein and which should not to be considered limiting of the invention, furthermore, it should be appreciated for a person skilled in the art that various modifications or variations can be made to the invention without departing from the spirit and protecting scope of the present invention, and such variations or variations would be covered within the protection scope of the invention.

What is claimed is:

1. A device for identity authentication management, comprising:
a client, which comprises a plurality of terminal units and multiple fingerprint sensors interconnecting with each of the terminal units respectively,
wherein each of the fingerprint sensors includes a collection and identification device for collecting fingerprint information and a memory for storing fingerprint information and user information corresponding to the fingerprint information, and the terminal units being used for registering or recognizing the fingerprint information collected by the fingerprint sensors; and
a background, which comprises an identity authentication server interconnecting with the terminal units and a plurality of application management areas interconnecting with the identity authentication server,
wherein application units and application information are included in the application management areas, when the fingerprint information is registered or recognized by the terminal units, the user information corresponding to the fingerprint information is generated or compared by the identify authentication server, and in the application management areas operations on the application units and application information can be performed

2. The device for identity authentication management as claimed in claim 1, wherein the identity authentication server includes a user authentication unit for identifying user identity and a user archive management unit for storing the registered user information.

3. The device for identity authentication management as claimed in claim 1, wherein the terminal units interconnect with the identity authentication server and the identity authentication server interconnects with the application management areas through a network respectively.

4. The device for identity authentication management as claimed in claim 1, wherein the application units in the application management areas are selected from the group consisting of game, mail, website or any combination thereof.

5. The device for identity authentication management as claimed in claim 1, wherein the application information in the application management areas includes user name, password or the like.

6. The device for identity authentication management as claimed in claim 1, wherein each of the application units in the application management areas includes a friend's management unit, in which friends and the operations on the friends can be managed by exchanging the fingerprint information.

7. The device for identity authentication management as claimed in claim 6, wherein each of the application units in the application management areas includes a chat unit, and the client being provided with a chat software for encrypting or decrypting chat information in the chat unit.

8. A method for identity authentication management utilizing the device as claimed in claim 1, comprising the steps of:
(A) extracting fingerprint information of users by means of the collection and identification devices of the fingerprint sensors;
(B) registering or recognizing the collected fingerprint information by the terminal units;
(C) generating new user information from the registered fingerprint information or comparing the user information corresponding to the fingerprint information with the user information stored by the identity authentication server;
(D) performing operation on the application units or application information in the application management areas by users.

9. The method for identity authentication management as claimed in claim 8, wherein the collection and identification devices of the fingerprint sensors extract the fingerprint information of users, and the terminal units registering the collected users information corresponding to the fingerprint information, and the user authentication unit of the identity authentication server of the background generating new users from the registered fingerprint information, and storing the new user information in the user archive management unit of the identity authentication server.

10. The method for identity authentication management as claimed in claim 8, wherein the collection and recognition devices of the fingerprint sensors extract the fingerprint information of users, and the terminal units recognizing the collected fingerprint information, and the user authentication unit of the identity authentication server of the background comparing the user information stored in the user archive management unit with the user information corresponding to the fingerprint information.

11. The method for identity authentication and management as claimed in claim 8, wherein the operation on the application units or application information for a user is selected from deletion, addition or modification, or any combination thereof.
